(19) United States
(12) Patent Application Publication
(10) Pub. No.: US 2014/0278105 A1
(43) Pub. Date: Sep. 18, 2014

(54) COMPUTING APPARATUS AND METHOD FOR PROVIDING TRANSPORTATION INFORMATION

(71) Applicant: Nimbler World, Inc., San Carlos, CA (US)

(72) Inventor: John R. Canfield, San Carlos, CA (US)

(73) Assignee: Nimbler World, Inc., San Carlos, CA (US)

(21) Appl. No.: 14/213,752

(22) Filed: Mar. 14, 2014

Related U.S. Application Data
(60) Provisional application No. 61/802,505, filed on Mar. 16, 2013.

(51) Int. Cl. G01C 21/00

(52) U.S. Cl. CPC G01C 21/00
USPC 701/538

(57) ABSTRACT

A computing apparatus includes at least one interface that receives a request for at least one route to an end destination. The interface provides image icons for transportation modes for use for the route, wherein each of the image icons corresponds to a different transportation mode. The interface receives an activation of at least two of the image icons, wherein the activation represents that the corresponding transportation modes have been selected. A processor is coupled to the user interface and receives a notification of the selection of the transportation modes and obtains a plan that includes the route, wherein the route includes a combination of the selected transportation modes. The processor transmits an image representative of the plan to the interface to enable a user to use the plan to travel to the end destination via the combination of the selected transportation modes.

### RELATED APPLICATION

This application claims the benefit of U.S. Provisional Patent Application No. 61/802,505 filed Mar. 16, 2013, which is expressly incorporated by reference herein in its entirety.

### BACKGROUND

The field of the invention relates generally to a computing device or apparatus and, more particularly, to a computing device or apparatus that facilitates providing transportation information, such as one or more routes or itineraries to a destination, wherein the routes or itineraries consider and include a combination of multiple transportation modes.

At least some known software modules or applications can be used with a computing device or apparatus, such as a handheld computing device, to provide transportation information, such as images of maps and/or route information to a desired end destination. For example, at least some known software modules or applications on a computing device or apparatus enable a user to input information, such as a starting location and a desired end location. Based on the information, the user is provided with at least one route that can be used to reach the desired end destination based on one transportation mode. For example, the user can be provided with a route to an end destination that can be used via a car or a route that can be used via a bicycle.

While such software modules or applications provide routes to a user for arriving at an end destination, there are limitations with respect to the transportation mode that are considered when obtaining the route. At least some known software modules or applications are unable to provide routes based on a combination of different transportation modes. For example, if a user selects the transportation mode as a bicycle for a route, then the user will be provided with a bicycling route to a desired end destination. The user cannot obtain a route that considers or includes, for example, a combination of a bicycle and mass transit or a combination of car and mass transit. As such, a user may need to obtain two separate routes for arriving at a destination when the user wants to use more than one mode of transportation.

### BRIEF DESCRIPTION

In one embodiment, a computing apparatus is provided that facilitates providing transportation information such that more than one transportation mode can be used. The computing apparatus includes at least one interface that is configured to receive a request for at least one route to an end destination. The interface is also configured to provide a plurality of image icons for a plurality of transportation modes for use for the route, wherein each of the image icons corresponds to a different transportation mode. The interface is further configured to receive an activation of at least two of the image icons, wherein the activation represents that the corresponding transportation modes have been selected. The computing apparatus includes a processor that is coupled to the user interface. The processor is programmed to receive a notification of the selection of the transportation modes and to obtain a plan that includes the route, wherein the route includes a combination of the selected transportation modes. The processor is further programmed to transmit an image representative of the plan to the interface to enable a user to use the plan to travel to the end destination via the combination of the selected transportation modes.

In another embodiment, a method of providing transportation information to a user using a computing apparatus that includes at least one interface and a processor is provided. The method includes receiving a request for at least one route to an end destination, via the interface. A plurality of image icons for a plurality of transportation modes are provided, via the interface, for use for the route, wherein each of the image icons corresponds to a different transportation mode. An activation of at least two of the plurality of image icons is received, via the interface, wherein the activation represents that the corresponding transportation modes have been selected. A notification of the selection of the transportation modes is transmitted from the interface to the processor. A plan that includes the route is obtained, via the processor, wherein the route includes a combination of the selected transportation modes. An image representative of the plan is transmitted from the processor to the interface to enable a user to use the plan to travel to the end destination via the combination of the selected transportation modes.

In yet another embodiment, at least one non-transitory computer-readable storage medium having computer-executable instructions embodied thereon is provided, wherein, when executed by at least one processor, the computer-executable instructions cause the processor to receive a signal representative of a request for at least one route to an end destination. The computer-executable instructions further cause the processor to generate a plurality of image icons for a plurality of transportation modes for use for the route, wherein each of the image icons corresponds to a different transportation mode. The computer-executable instructions also cause the processor to transmit the image icons to at least one interface to enable the presentation of the image icons to a user and to receive a notification of a selection of at least two of the transportation modes, wherein the selection is performed by an activation of the corresponding image icons. The computer-executable instructions further cause the processor to obtain a plan that includes the route, wherein the route includes a combination of the selected transportation modes, and to transmit an image representative of the plan to the interface to enable the user to use the plan to travel to the end destination via the combination of the selected transportation modes.

### BRIEF DESCRIPTION OF THE DRAWINGS

FIG. 1 is a block diagram of an exemplary system that includes a computing apparatus that is configured to provide transportation information to a user;

FIG. 2 is a swimlane diagram of an exemplary method for providing transportation information using the computing apparatus shown in FIG. 1; and

FIGS. 3A-3D are diagrams of exemplary outputs that are generated by the computing apparatus shown in FIG. 1.

### DETAILED DESCRIPTION

The exemplary computing apparatus and method described herein overcome disadvantages of known systems and methods that are used to provide transportation information. For example, as described herein, the exemplary computing apparatus and method facilitate providing transportation information such that the information considers and includes a combination of multiple transportation modes that can be used to arrive at an end destination. In some embodiments, the computing apparatus includes at least one interface for receiving a request for at least one route to an end destination and the interface also provides image icons that correspond to different transportation modes that can be used for the route. A user can activate at least two of the image icons to select the corresponding transportation modes. After the selection, a processor that is coupled to the interface can obtain a plan that includes the route such that the route includes a combination of the selected transportation modes. The processor can transmit an image representative of the plan to the interface such that the user is enabled to use the plan to travel to the end destination via the combination of the selected transportation modes. Accordingly, the user is not limited to receiving a route that includes only one mode of transportation and the user will no longer need to obtain two separate routes for arriving at a destination when the user wants to use more than one mode of transportation.

FIG. 1 is a block diagram of a system 100 for use in providing transportation information, such as routes or itineraries to various end destinations. System 100 includes a computing device or apparatus 102 that can be a desktop computer, laptop, mobile device, tablet, thin client, or other device. For example, in some embodiments, computing apparatus 102 includes a user interface 104 that receives at least one input from a user. In some embodiments, user interface 104 includes a keyboard 106 that enables the user to input pertinent information. Alternatively, user interface 104 can include, for example, a pointing device, a mouse, a stylus, a touch sensitive panel (e.g., a touch pad or a touch screen), a gyroscope, an accelerometer, a position detector, and/or an audio input interface (e.g., including a microphone).

In some embodiments, computing apparatus 102 includes a presentation interface 107 that presents information, such as input events and/or validation results, to the user. For example, presentation interface 107 includes a display adapter 108 that is coupled to at least one display device 110. Display device 110 can be a visual display device, such as a cathode ray tube (“CRT”), a liquid crystal display (“LCD”), an organic LED (“OLED”) display, and/or an “electronic ink” display. Alternatively, presentation interface 107 can include an audio output device (e.g., an audio adapter and/or a speaker) and/or a printer. In some embodiments, for example, when computing apparatus 102 is in the form of a type of tablet or a type of mobile device (i.e., smart phone), user interface 104 can be incorporated with presentation interface 107 such that presentation interface 107 can display images to a user and, at the same time, the user can input data or make selections using the display images via a touch screen (not shown) that is part of user interface 104.

Computing apparatus 102 also includes a central processor 114 and at least one non-transitory, computer readable storage medium, such as a memory device 118. Processor 114 can be coupled to user interface 104, presentation interface 107, and to memory device 118 via a system bus 120. In some embodiments, processor 114 communicates with the user, such as by prompting the user via presentation interface 107 and/or by receiving user inputs via user interface 104. In some embodiments, processor 114 communicates with user interface 104 by a wireless interface, such as a personal area network interface (e.g., “Bluetooth”). In some embodiments, processor 114 includes one or more software modules or applications that are executed within processor 114 to facilitate the processes described below in more detail.

In some embodiments, processor 114 is programmed by encoding an operation using one or more executable instructions and by providing the executable instructions in memory device 118. The term “processor” refers generally to any programmable system including systems and microcontrollers, reduced instruction set circuits (“RISC”), application specific integrated circuits (“ASIC”), programmable logic circuits (“PLC”), and any other circuit or processor capable of executing the functions described herein. This description is not intended to limit in any way by the definition and/or meaning of the term “processor.”

In some embodiments, memory device 118 includes one or more devices that enable information, such as executable instructions and/or other data, to be stored and retrieved. Moreover, in some embodiments, memory device 118 includes one or more computer readable media, such as, without limitation, dynamic random access memory (“DRAM”), static random access memory (“SRAM”), a solid state disk (e.g., an electrically erasable programmable read only memory (EEPROM) or a flash memory), an optical disk drive and/or a hard disk drive (HDD). In some embodiments, memory device 118 stores, without limitation, application source code, application object code, configuration data, additional input events, application states, assertion statements, validation results, and/or any other type of data.

In some embodiments, memory device 118 includes a plan database 119 that is configured to store data, including but not limited to plans that include various routes or itineraries that are generated by processor 114. The term “database” refers generally to any collection of data including hierarchical databases, relational databases, flat file databases, object-relational databases, object oriented databases, and any other structured collection of records or data that is stored in computer apparatus 102. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

Computing apparatus 102 also includes a communication interface 130 (e.g., Institute of Electrical and Electronics Engineers (IEEE) 802.11 standard or Bluetooth) that is coupled to processor 114 via system bus 120. Moreover, communication interface 130 can be coupled to, for example, a data management system 150 via a network 152 such that data management system 150 can communicate with computing apparatus 102. In some embodiments, network 152 can be the Internet, a local area network (LAN), a wide area network (WAN), a personal area network (PAN) or any combination thereof. In some embodiments, data management system 150 includes a server 153 that can be run on a computing device (not shown), such as a desktop computer having a processor (not shown). In some embodiments, server 153 includes a database 154 of transportation information, such as addresses and/or mapping information. In some embodiments, data management system 150 can be managed and/or run by a third party, such as Amazon or Microsoft.

During operation of computing apparatus 102, as explained in more detail below with respect to FIGS. 2 and 3A-3D, a user can request at least one route or itinerary to an end destination and computing apparatus 102 can provide the user with the routes or itineraries such that the routes or itineraries consider and use a combination of various transportation modes. For example, in some embodiments, presentation interface 107 can provide the user with an image representative of a prompt and the user can input the start and end destination using user interface 104 into the prompt. Presentation interface 107 can also provide the user with image icons that correspond to different transportation modes. Using the image icons, the user can select two or more transportation modes that the user would like to use to arrive at the end destination. After the selection, processor 114 can obtain a plan from server 153 or from within. The plan includes at least one route or itinerary to arrive at the end destination, wherein the route or itinerary includes a combination of the selected transportation modes. Processor 114 can transmit an image representative of the plan to presentation interface 107 such that the user can view the plan and is enabled to use the plan to travel to the end destination via the combination of the selected transportation modes. Therefore, the user is not limited to receiving a route or itinerary that includes only one mode of transportation and the user will no longer need to obtain two separate routes for arriving at a destination when the user wants to use more than one mode of transportation.

FIG. 2 is a swimlane diagram 200 of an exemplary method for providing transportation information using computing apparatus 102 (shown in FIG. 1). This method may be embodied within a plurality of computer-executable instructions stored in one or more memories, such as one or more computer-readable storage mediums. The computer storage mediums include non-transitory media, which may include volatile and nonvolatile, removable and non-removable mediums implemented in any method or technology for storage of information such as computer-readable instructions, data structures, program modules or other data. The instructions may be executed by one or more processors to perform the functions described herein.

In operation 201, processor 114 generates an initial prompt image that includes, for example, a prompt for a user to input a starting location and an end destination. The initial prompt image is transmitted to presentation interface 107 in operation 202. Presentation interface displays the initial prompt image to a user in operation 203. The user can then input the starting location and the end destination via user interface 104 and user interface 104 receives the input in operation 204. For example, in some embodiments, the user can directly touch the screen (not shown) on presentation interface 107 to input the information or use keyboard 106 (shown in FIG. 1) or mouse (not shown). In some embodiments, the user can use a drop down menu within the initial prompt image and use current location or search for existing addresses contained within computing apparatus 102. In some embodiments, the current location and/or addresses can be obtained by computing apparatus 102 via data management system 150 (shown in FIG. 1).

In operation 205, user interface 104 transmits a signal representative of the input of the starting location and the end destination to processor 114. Processor 114 receives the signal in operation 206. In operation 207, processor 114 generates a plurality of image icons corresponding to a plurality of transportation modes such that each image icon corresponds to a different transportation mode. In some embodiments, the different transportation modes can include a bicycle mode, an automobile mode (i.e., car), a walking mode, one or more different types of public transportation modes (i.e., bus, train, and/or subway system), and one or more different types of private transportation modes (i.e., taxi, limousine service, and/or shuttle service). For example, FIG. 3A illustrates an exemplary output 300 generated by processor 114. Referring to FIG. 3A, output 300 includes image icons 302 of the different transportation modes (Caltrain, Muni Bus, BART, Muni Tram, and bike). In some embodiments, as explained in more detail below, the image icons generated by processor 114 will only include the icons that are relevant to a particular route based on the start location and end destination entered by the user. For example, FIG. 3A does not include transportation modes or agencies that do not efficiently serve the route chosen by the user.

Referring to FIG. 2, processor 117 transmits the image icons to presentation interface 107 in operation 208 and presentation interface 107 displays the image icons in operation 209 such that the user can view the image icons. In operation 210, user interface 104 receives an activation of at least two of the image icons. For example, the user can directly click on the image icons on the screen of presentation interface 107 or the user can use a mouse to click on the image icons. By selecting two or more of the image icons, the user is selecting two or more transportation modes that the user desires to use to arrive at the end destination. For example, referring to FIG. 3A, the user selected a combination of Caltrain, Muni Bus, BART, Muni Tram to arrive at the end destination.

Referring to FIG. 2, in operation 211, user interface 104 transmits a notification of the selection of the transportation modes to processor 114. Processor 114 receives the notification in operation 212. In operation 213, processor transmits the notification to server 153 in operation 213. Server 153 receives the notification in operation 214. In operation 215, server 153 generates a plan that includes one or more routes or itineraries that include a combination of the selected transportation modes. In some embodiments, server 153 generates the plan by using the information stored in database 154 (shown in FIG. 1). In operation 216, server 153 transmits the plan to processor 114. In operation 217, processor 114 obtains the plan. In alternative embodiments, processor 114 can obtain the plan from itself by generating the plan instead of the server 153 generating the plan. When generating the plan, processor 114 may obtain information from database 154 within server 153, such as mapping and/or route information.

In operation 218, processor 114 transmits the plan to memory device 118 (shown in FIG. 1), wherein the plan is stored in plan database 119 (shown in FIG. 1). In operation 219, processor 114 generates an image representative of the plan and, in operation 220, processor 114 transmits the image to presentation interface 107. In operation 221, presentation interface 107 displays the image such that the user can view the routes or itineraries to enable the user to use one of the routes or itineraries to arrive at the end destination using the combination of the selected transportation modes.

In some embodiments, the plan is a data object containing the routes or itineraries going between the user-requested start location and the end destination. In some embodiments, the plan is generated based on time efficiency. For example, referring to FIG. 3A, output 300 includes a plan with several routes or itineraries 308 based on the combination of transportation modes selected by the user. These routes or itineraries 308 are the best or optimal choices out of all those combination of selected transportation modes based on, for example, time efficiency. In some embodiments, the criteria for what are the best choices can be determined by processor 114 from the user either explicitly using settings or implicitly based on the user's past behavior. When time efficiency is used as the criterion, then any itinerary or route that leaves earlier or arrives later will not be generated nor shown by computing apparatus 102.

Referring to FIG. 2, in some embodiments, every time a new routing request is made by the user, operations 201-221 are repeated such that a new data plan is generated for each routing request and each plan is stored in plan database 119. In some embodiments, prior to each plan being transmitted from processor 114 to memory device 118 for storage in operation 218, processor 114 makes further determinations. For example, in step 222, processor 114 compares the newly generated plan that processor 114 obtains from server 153 with the other plans in the database 119 within memory device 118. In step 223, processor 114 determines whether there are any equivalent plans, such as plans that have similar or identical starting locations and end destinations. If there is an equivalent plan, then the newly generated plan is merged with the equivalent plan in step 224, wherein the merged plan includes the combination of both the two plans. The merged plan is then transmitted to memory device 118 via operation 218. However, if the two plans are identical, then they are not merged and one of the plans is transmitted to memory device 118 for storage. If there are no equivalent plans to the newly generated plan, then the newly generated plan is transmitted to memory device via operation 218.

In some embodiments, after activating various image icons, the user can activate additional image icons that were not previously activated for the same end destination and new plans with different routes or itineraries can be generated. For example, in operation 230, user interface 104 can receive an activation of an additional image icon for a selection of another transportation mode. User interface 104 transmits notification of the selection of another transportation mode to processor 114 in operation 231. Operations 212-224 can then be repeated and the new routes or itineraries can be provided to the user. For example, FIG. 3B illustrates an output 330 in which all the transportation modes that were selected for output 300 (shown in FIG. 3A) are included and the bike transportation mode is selected as well. Referring to FIG. 3B, in some embodiments, bike mode means the user is taking the bike on a trip, including bringing the bike on board the other transportation modes, such as the train or vehicle. As such, in some embodiments, the bike mode is mutually exclusive with walking. As shown in FIG. 3B, new routes or itineraries 332 are presented to the user that combine the bike with the other selected transportation modes.

FIG. 3C illustrates an output 340 that includes the details of the first route or itinerary of output 330 (shown in FIG. 3B). For example, using user interface 104, the user can choose to see the details of the route or itinerary. Referring to FIG. 3C, the route or itinerary maps out the bike route from the starting location to the BART station (leg 342) and from the closest BART station on the other end to the end destination (leg 344). Output 340 shows the map that leg 342 is selected, in which case, a description of leg 342 is provided. The user can navigate between legs by using user interface 104 to select the leg or by using the arrow buttons 346 on the upper right corner of output 340.

Referring to FIG. 2, in some embodiments, the user can deactivate some the previously activated image icons for which new plans with different routes or itineraries can be generated. For example, in operation 234, user interface 104 receives a deactivation of one of the previously activated image icons such that the corresponding transportation mode is unselected. User interface 104 transmits the notification of the revised selection to processor 114 in operation 236. Operations 212 and 224 can then be repeated such that an updated plan with new routes or itineraries is generated and an updated image based on the updated plan is presented to the user. For example, FIG. 3D illustrates an output 360 in response to a deactivation of the one of the transportation modes (Caltran). Referring to FIG. 3D, all the previous routes or itineraries that included Caltran are removed from the list and more BART routes are visible to the user.

In some embodiments, an additional or new request for a new route for a different end destination from a new start location can be made. For example, operations 204-224 can be repeated for a different starting locations and/or end destinations. However, prior to transmitting the notification to server 153 in operation 213, processor 114 compares the new request with the plans that were previously generated by server 153 and previously obtained by processor 114 and already stored in database 119 in operation 250. In operation 252, processor 114 determines whether there are any suitable or equivalent plans (i.e., plans that are based on similar or identical starting locations and end destinations). If a suitable or equivalent plan is identified, then the notification is not transmitted to server 153 in operation 213 and server 153 does not generate a new plan in operation 215. Instead, the equivalent plan that is already stored in database 119 is used for operations 219-221. If, however, no suitable or equivalent plan is identified, then processor 114 transmits the notification pursuant to operation 213 and a new plan is generated pursuant to operation 215.

As described above, there are several criterion that are used by processor 114 to determine the most suitable plans that eventually displayed to a user. As also described above, one criterion is that the itinerary be close to the time requested by the user. This means a time range from the requested departure time until sometime in the future, such as between 3-6 hours. As such, processor 114 can support “arrive-by” routing in which the user specifies when they want to arrive at a destination and the user will be presented with all the itineraries leaving prior to that time and that will arrive before the requested time. There may be many itineraries stored in a plan, but only the ones for a relevant time will be shown.

In some embodiments, transit agency schedules often repeat day after day. But they frequently vary by day of the week or holidays. Another criterion for matching itineraries to the user request is to find a stored itinerary in the plan that was stored on a day with the same transit schedule as the users' request. For example, if a user requests a trip on Monday Mar. 4, 2013, processor 114 can use an itinerary from Tuesday, February 26 if the transit agencies in the itinerary all had the same schedule on March 4 as they did on February 26.

Transit agencies sometimes update their schedules. Once updated schedules are in force, itineraries based on the old schedules cannot be used. This is a third criterion for whether to use a stored itinerary. Based on the above criteria, processor 114 collects all the itineraries that are relevant to the user's request and presents them to the user.

In some embodiments, the stored itineraries will fully cover all the possible itineraries for a request, but sometimes they will be inadequate. The request tracking data object keeps track of all the requests that were made to the routing algorithm used by processor 114 to determine whether the itineraries stored are complete or not. Every time a new routing request is sent to the routing algorithm, a request tracking data object records the users' requested trip time and the returned itinerary. If a later request comes in, it is compared against the range of request times and itineraries from previously stored results. For example, suppose the user requested a trip starting at 10:00 am and received itineraries ranging from 10:15 until 1:15 pm. If on a later day, they request a trip starting at 9:30 am, the request tracking data objects would show that no previous request covered that early a request time. As a result, the processor 114 would call the routing algorithm to generate new routes starting at 9:30 am. But if the user came back and requested again at 10:00 am, the request tracking data object would indicate there already are all the relevant stored itineraries.

In some embodiments, processor 114 stores the user's mode selections in a mode selection data structure (not shown) within memory device 118. If an itinerary includes a mode that the user has deactivated in their mode selections, then that itinerary is not shown in the results. This is one additional criterion for the displaying the itineraries described above.

In some embodiments, when a new request is made, information about the user's mode requests will be included in that request. In particular, any excluded modes will be specified. Also the choice of transportation modes, such as bike versus walk, will be specified.

The request tracking data objects described above will also include information about any mode selections associated with those requests, in some embodiments. For example, if requests have been made for a particular set of mode selections, but then the user changes those settings to a combination they have never requested before, new requests to, for example, data management system 150 and server 153, will be made and new requests tracking objects will be created associated with those mode selections settings.

In some embodiments, in order to determine which mode selections buttons to display to the user, processor 114 first looks through the itineraries stored in a plan. Processor 114 will only enable the user to see buttons for the transit agency modes that are in the current plan. Mode buttons for modes that are always available will be shown as well to the user, such as bicycle.

In some embodiments, for the first time that a particular start location and end destination is requested, the request to processor 114 will be made including all modes. As such, processor 114 can determine which mode buttons to show to the user.

The above-described embodiments of an apparatus and method facilitate providing transportation information such that the information considers and includes a combination of multiple transportation modes that can be used to arrive at an end destination. In some embodiments, the computing apparatus includes at least one interface for receiving a request for at least one route to an end destination and the interface also provides image icons that correspond to different transportation modes that can be used for the route. A user can activate at least two of the image icons to select the corresponding transportation modes. After the selection, a processor that is coupled to the interface can obtain a plan that includes the route such that the route includes a combination of the selected transportation modes. The processor can transmit an image representative of the plan to the interface such that the user is enabled to use the plan to travel to the end destination via the combination of the selected transportation modes. Accordingly, the user is not limited to receiving a route that includes only one mode of transportation and the user will no longer need to obtain two separate routes for arriving at a destination when the user wants to use more than one mode of transportation.

It should be noted that requesting two separate routes (i.e., one for using a bike mode and one for using a transit mode) is not equivalent to receiving one route having a combination of different transportation modes because, as described above, there are many transfer points from, for example, bike to transit, that need to be evaluated.

Exemplary embodiments of an apparatus and a method for use in providing transportation information are described above in detail. The apparatus and method are not limited to the specific embodiments described herein, but rather, components of the apparatus and/or steps of the method may be utilized independently and separately from other components and/or steps described herein. For example, the apparatus may also be used in combination with other systems and methods, and is not limited to practice with only the system as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing apparatus comprising:
at least one interface configured to:
receive a request for at least one route to an end destination;
provide a plurality of image icons for a plurality of transportation modes for use for the at least one route, wherein each of the plurality of image icons corresponds to a different transportation mode of the plurality of transportation modes; and
receive an activation of at least two of the plurality of image icons, wherein the activation represents that the corresponding at least two of the plurality of transportation modes have been selected; and
a processor coupled to said at least one interface, wherein said processor is programmed to:
receive a notification of the selection of at least two of the plurality of transportation modes;
obtain a plan that includes the at least one route, wherein the at least one route includes a combination of the at least two plurality of transportation modes selected; and
transmit an image representative of the plan to said at least one interface to enable a user to use the plan to travel to the end destination via the combination of the at least two plurality of transportation modes selected.

2. The computing apparatus in accordance with claim 1, wherein the plurality of transportation modes include a bicycle mode, an automobile mode, a walking mode, one or more different types of public transportation modes, and one or more different types of private transportation modes.

3. The computing apparatus in accordance with claim 1, wherein said at least one interface is further configured to receive a request for a deactivation of at least one of the at least two of the previously activated plurality of image icons.

4. The computing apparatus in accordance with claim 3, wherein said processor is further programmed to:
obtain an updated plan based on the deactivation; and
transmit an updated image based on the updated plan to said at least one interface.

5. The computing apparatus in accordance with claim 1, further comprising a memory device coupled to said processor, wherein said memory device comprises a plan database and said memory device is configured to:
receive the plan from said processor; and
store the plan in said plan database, wherein said plan database includes a plurality of previously generated plans.

6. The computing apparatus in accordance with claim 5, wherein said processor is further programmed to:
compare the plan with the plurality of previously generated plans, prior to the plan being stored in said plan database;
identify whether the plan is equivalent to at least one of the plurality of previously generated plans;
merge the plan with at least one of the plurality of previously generated plans that is identified as being equivalent to the plan; and
store the merged plan in said plan database.

7. The computing apparatus in accordance with claim 5, wherein said at least one interface is further configured to receive an additional request for at least one additional route for an additional end destination, wherein said processor is further programmed to:
compare the additional request with the plan and the plurality of previously generated plans stored in said plan database to determine whether the plan or one of the plurality of previously generated plans are suitable for use for the additional request; and
obtain an additional plan when the plan and the plurality of previously generated plans stored in said plan database are not suitable for use for the additional request.

8. A method of providing transportation information to a user using a computing apparatus that includes at least one interface and a processor, said method comprising:
receiving a request for at least one route to an end destination, via the at least one interface;
providing a plurality of image icons for a plurality of transportation modes, via the at least one interface, for use for the at least one route, wherein each of the plurality of image icons corresponds to a different transportation mode of the plurality of transportation modes;
receiving an activation of at least two of the plurality of image icons, via the at least one interface, wherein the activation represents that the corresponding at least two of the plurality of transportation modes have been selected;
transmitting a notification of the selection of at least two of the plurality of transportation modes from the at least one interface to the processor;
obtaining a plan that includes the at least one route, via the processor, wherein the at least one route includes a combination of the at least two plurality of transportation modes selected; and
transmitting an image representative of the plan from the processor to the at least one interface to enable a user to use the plan to travel to the end destination via the combination of the at least two plurality of transportation modes selected.

9. The method in accordance with claim 8, wherein providing a plurality of image icons for a plurality of transportation modes comprises providing a plurality of image icons for a bicycle mode, an automobile mode, a walking mode, one or more different types of public transportation modes, and one or more different types of private transportation modes.

10. The method in accordance with claim 8, further comprising receiving a request for a deactivation of at least one of the at least two of the previously activated plurality of image icons, via the at least one interface.

11. The method in accordance with claim 10, further comprising:
obtaining an updated plan based on the deactivation, via the processor; and
transmitting an updated image based on the updated plan to the at least one interface.

12. The method in accordance with claim 8, further comprising:
transmitting the plan from the processor to a memory device that includes a plan database; and
storing the plan in the plan database, wherein the plan database includes a plurality of previously generated plans.

13. The method in accordance with claim 12, further comprising:
comparing the plan with the plurality of previously generated plans via the processor, prior to the plan being stored in the plan database;
identifying whether the plan is equivalent to at least one of the plurality of previously generated plans;
merging the plan with at least one of the plurality of previously generated plans that is identified as being equivalent to the plan; and
storing the merged plan in the plan database.

14. The method in accordance with claim 12, further comprising:
receiving an additional request for at least one additional route for an additional end destination, via the at least one interface;
comparing the additional request with the plan and the plurality of previously generated plans stored in the plan database to determine whether the plan or one of the plurality of previously generated plans are suitable for use for the additional request, via the processor; and
obtaining an additional plan when the plan and the plurality of previously generated plans stored in the plan database are not suitable for use for the additional request.

15. At least one non-transitory computer-readable storage medium having computer-executable instructions embodied thereon, wherein, when executed by at least one processor, the computer-executable instructions cause the at least one processor to:
receive a signal representative of request for at least one route to an end destination;
generate a plurality of image icons for a plurality of transportation modes for use for the at least one route, wherein each of the plurality of image icons corresponds to a different transportation mode of the plurality of transportation modes
transmit the plurality of image icons to at least one interface to enable the presentation of the plurality of image icons to a user;
receive a notification of a selection of at least two of the plurality of transportation modes, wherein the selection is performed by an activation of the corresponding at least two of the plurality of image icons;
obtain a plan that includes the at least one route, wherein the at least one route includes a combination of the at least two plurality of transportation modes selected; and
transmit an image representative of the plan to the at least one interface to enable the user to use the plan to travel to the end destination via the combination of the at least two plurality of transportation modes selected.

16. The at least one non-transitory computer-readable storage medium of claim 15, wherein the plurality of transportation modes include a bicycle mode, an automobile mode, a walking mode, one or more different types of public transportation modes, and one or more different types of private transportation modes.

17. The at least one non-transitory computer-readable storage medium of claim 15, wherein the computer-executable instructions further cause the at least one processor to:
receive a notification that a request for a deactivation of at least one of the at least two of the previously activated plurality of image icons has been made;
obtain an updated plan based on the deactivation; and
transmit an updated image based on the updated plan to the at least one interface.

18. The at least one non-transitory computer-readable storage medium of claim 15, wherein the computer-executable instructions further cause the at least one processor to transmit the plan to a memory device for storage in a plan database, wherein the plan database includes a plurality of previously generated plans.

19. The at least one non-transitory computer-readable storage medium of claim 18, wherein the computer-executable instructions further cause the at least one processor to:
compare the plan with the plurality of previously generated plans prior to the plan being stored in the plan database;
identify whether the plan is equivalent to at least one of the plurality of previously generated plans;
merge the plan with at least one of the plurality of previously generated plans that is identified as being equivalent to the plan; and
store the merged plan in the plan database.

20. The at least one non-transitory computer-readable storage medium of claim 18, wherein the computer-executable instructions further cause the at least one processor to:
receive a notification that an additional request for at least one additional route for an additional end destination has been made;
compare the additional request with the plan and the plurality of previously generated plans stored in the plan database to determine whether the plan or one of the plurality of previously generated plans are suitable for use for the additional request; and
obtain an additional plan when the plan and the plurality of previously generated plans stored in the plan database are not suitable for use for the additional request.
